(19) United States
(12) Patent Application Publication
(10) Pub. No.: US 2026/0008971 A1
(43) Pub. Date: Jan. 8, 2026

(54) APPARATUS AND METHOD FOR TREATING RAW MATERIALS, AND CARBON PRODUCED USING SAID METHOD

(71) Applicant: Merenas Trust Reg., Vaduz (LI)

(72) Inventor: Karl-Heinz HEMMERLE, Vaduz (LI)

(21) Appl. No.: 18/992,313

(22) PCT Filed: Jul. 7, 2023
(86) PCT No.: PCT/EP2023/068829

§ 371 Date: Jan. 8, 2025

(30) Foreign Application Priority Data
Jul. 8, 2022 (EP) 22183741.2

(51) Int. Cl. C10J 3/62; C10B 17/00; C10B 41/08; C10J 3/74; C10J 3/82

(52) U.S. Cl. CPC C10J 3/62; C10B 17/00; C10B 41/08; C10J 3/74; C10J 3/82

(57) ABSTRACT

A device for the material treatment of raw materials includes a heating system, a distillation unit, a reaction unit, and a control device. The reaction unit can be charged with the raw materials for treatment. The heating system can be opened to be charged with the reaction unit, and closed. An exhaust gas line is provided to discharge exhaust gases from the reaction unit. The distillation unit has a cooling section with a device for forced cooling. Temperature sensors are provided in the region of the heating system and the distillation unit. An extraction device extracts gases from the reaction unit and generates negative pressure inside the reaction unit. The temperature sensors and the extraction device are connected to the control device. The device can be operated for the material treatment of raw materials to produce, for example, carbon.

### CROSS-REFERENCE TO RELATED APPLICATIONS

This application is a National Stage Application under 35 U.S.C. § 371(a) of PCT/EP2023/068829, filed on Jul. 7, 2023, which claims benefit of and priority to European Patent Application No. 22183741.2 filed on Jul. 8, 2022. The entire contents of the foregoing applications are incorporated by reference herein.

The invention relates to a device for the material treatment of raw materials. The device has a heating system, a distillation unit and a reaction unit, as well as a control device. The reaction unit can be charged with the raw materials for treatment. The heating system can be opened and closed to be charged with the reaction unit.

The invention further relates to a method for operating a device for the material treatment of raw materials and to a carbon produced by said method.

Devices known from the prior art are provided for the industrial treatment, in particular of waste rubber products, rubber products or rubber-like composite products, such as used tyres, steel rope-reinforced rubber belts, rubberised chain links and conveyor belts, as well as of crushed end-of-life vehicles, of organic renewable raw materials, such as wood, of contaminated carbon and contaminated soils. Light oil, gas, metals, in particular steel, and carbon are obtained. Conventional plants are based, for example, on the use of rotary kilns, fluidised-bed reactors and drums and processed compressed starting material in a chemically inert atmosphere with the exclusion of oxygen.

DE 199 30 071 C2 describes a method and a device for the recovery of organic substances and substance mixtures. The organic material is brought into contact with fluidised bed material of the combustion fluidised bed. The method produces final products in the form of gases with condensable substances and carbon-containing residues.

DE 44 41 423 A1 discloses a method and a device for obtaining usable gas from waste. The crushed waste is introduced into a gas-tight sealed drum. Gas is generated in the drum and separated from the simultaneously formed residue. The gas produced is split into a cracking gas in a gas converter with the supply of air and in the presence of a glowing coke bed. The heat required in the method is transferred by a gas in direct contact with the material to be recycled. A partial stream of the cracking gas emerging from the gas converter is used for the transfer of the heat to the gas.

DE 40 11 945 C1 reveals a method for degassing organic substances, such as, for example, domestic and industrial waste and the like, in a heatable chamber. In the method, the starting materials are introduced into the chamber with compression and pass through the chamber cross-section while retaining the compressed state. The heat is supplied via the chamber walls which are in pressure contact with the compressed material. The gaseous products formed are removed at elevated pressure. The chamber is sealed in a gas-tight manner in its charging region by the compressed material. By recompressing the solid residues, an increased flow resistance is achieved in the outflow region of the gaseous products.

DE 39 32 803 A1 discloses a reaction method of organic materials with the addition of boric acid/boron oxide and organic nitrogen compounds in a non-oxidising atmosphere to carbon and graphite.

The operation of conventional plants requires increased expenditure on materials, energy and logistics. Thus, for example, the production of a fluidised bed in fluidised bed reactors requires an increased energy expenditure, since on the one hand the fluidised bed must be produced and maintained and on the other hand the materials to be utilised must be worked up mechanically in such a way that they effectively contact the fluidised bed. The crushing or compaction of the starting materials in the preparation and during the recycling procedure also entails high energy costs.

WO 2007/053088 A1 describes a method and a device for treating materials from hydrocarbons. The materials are fed into an inner container, which in turn can be arranged in an outer container. Both containers are each closed with a cover element. The hydrocarbon material is heated by means of microwaves or high-frequency irradiation. The resulting exhaust gases are discharged from the containers through a gas outlet. Two or more containers can be operated in parallel and connected to a gas cleaning system to maintain a nearly continuous gas flow through the gas cleaning system.

WO 2010/012275 A2 discloses a device for treating materials with a cylindrical furnace and a control of the process. The inner surfaces of the furnace are provided with an insulating layer of an inorganic heat insulating material. Heating elements are arranged at or on the inner surfaces of the insulating layers. The control of the process by controlling the temperature of the heating elements serves to achieve a high yield of carbon, oil and fuel gas.

DE 10 2012 109 874 A1 discloses a device for the material treatment of raw materials with a heating system, a distillation unit and a reaction unit which can be charged with the raw materials, and a method for operating such a device. The heating system, which can be opened and closed to be charged with the reaction unit, has a head element and a jacket element which is firmly connected to the head element, as well as support elements. The head element is connected to the support elements which can be varied in length in the vertical direction in such a way that by changing the length of the support elements between two end positions, the heating system is opened and closed in the vertical movement direction.

US 2003/010266 A1 discloses an apparatus and method for the thermal decomposition of waste products, for the production of recyclable raw materials, for the recovery of waste heat, and for converting the same into energy. The apparatus and method are designed for processing feed material, with a first reaction segment arranged in a combustion chamber and a second reaction segment located outside the combustion chamber. The exhaust gases are oxidized by a thermal air purifier. An exhaust gas unit is provided for directing the exhaust gases from the reaction segments through a thermal oxidation unit.

DE 102 19 440 A1 relates to a low-temperature method for separating steel-rubber products or similar composite materials to obtain carbon granulate, oil, residual gas, and metallic components. The process is carried out at atmospheric pressure and without inert media and can be performed as a discontinuous batch operation.

DE 10 2014 014 816 A1 discloses an apparatus for performing a medium-temperature carbonization process, with a reactor vessel of cylindrical shape that can be heated in a furnace.

DE 10 2005 001 569 A1 describes an installation for carbonization, comprising a chamber for receiving the material to be carbonized and a heating chamber located beneath it. A gas-conducting connection is formed between the chamber and the heating chamber, through which the gases generated in the chamber are directed into the heating chamber, where they serve as additional fuel for heating.

US 2008/207442 A1 discloses a porous carbon with a large surface area and a method for producing the carbon. The carbon is derived from biomass and has large mesopores and micropores, which enhance the adsorption of materials and gas storage capacity.

WO 2017/035086 A1 describes a carbohydrate-carbon material, which is produced, for example, through a method for manufacturing a monolithic or particulate carbon adsorption medium. During the manufacturing process, a precursor carbohydrate material is compressed into a near-final shape, then heated in a controlled manner in an inert gas environment to thermally decompose the carbohydrate material into solid carbon. The carbon can then be further treated to increase its surface area through chemical or physical activation.

It is an object of the present invention to provide an improved device and a method for the treatment of different used rubber products, in particular used tyres and rubber composite products or rubber-like composite products, renewable raw materials, such as wood, shells or fruits, electronic scrap, such as computers and mobile phones, motor vehicles and storage media, such as batteries, as well as contaminated carbon. The composite products are to be separated and valuable components, such as carbon, light oil, gases and, if appropriate, metallic materials, are to be recovered. The contaminated carbon should be separated from the respective impurities. The device should be able to be operated cost-effectively with minimal energy input and the method should be able to be carried out with minimal expenditure, in particular time. The raw materials recovered by the method should remain as unchanged as possible in the starting structure in order, for example, to be able to be returned to their original use. In addition, the carbon recovered by the method should have advantageous material properties different from conventional carbons.

The object is achieved by a device according to the invention for the material treatment of raw materials. The device has a heating system, a distillation unit and a reaction unit, as well as a control device. The reaction unit can be charged with the raw materials. The heating system can be opened and closed to be charged with the reaction unit. An exhaust gas line for discharging the exhaust gases from the reaction unit is formed between the reaction unit and the distillation unit. The distillation unit has a cooling section.

According to the concept of the invention, temperature sensors are formed in the region of the heating system and the distillation unit. In addition, the cooling section of the distillation unit has a device for forced cooling. The device for the forced cooling of the cooling section makes it possible for the cooling section, in comparison, for example, to free convention, to be subjected to a specific flow of a heat carrier fluid-in particular gaseous or liquid-for the removal of heat, or for the flow of heat to flow around it. The cooling section is arranged inside an air guide housing for the targeted conduction of ambient air over the cooling section and/or is formed from at least one coaxial tube for the conduction of gases inside an internal tube and for the conduction of a heat carrier fluid in the intermediate space between the outside of the internal tube and the inside of the external tube. The coaxial tube can in particular be double-walled. The heat carrier fluid is preferably in the liquid state of aggregation and can be specifically water or glycol.

The device for the material treatment of raw materials has an extraction device for extracting gases from the reaction unit and generating a negative pressure within the reaction unit. The negative pressure refers to the pressure of the surroundings of the device. The extraction device can be formed as a pump, in particular as a diaphragm pump.

According to the invention, the temperature sensors and the extraction device are connected to the control device.

According to a further development of the invention, at least two of the temperature sensors for determining the temperature within the reaction unit are arranged in an intermediate space formed between the reaction unit and a jacket element of the heating system in the closed state of the heating system.

According to an advantageous embodiment of the invention, the exhaust gas line between the heating system and the distillation unit has a heating device for heating the exhaust gas line. The heating device, which preferably completely surrounds the exhaust gas line and is advantageously electrically operated, is connected to the control device.

At least one temperature sensor for determining the temperature of exhaust gases discharged from the heating system is preferably provided on the exhaust gas line between the heating system and the distillation unit.

According to the invention, a connection element for connecting to a device for introducing a gaseous flushing medium, in particular into the reaction unit, is provided on the exhaust gas line between the heating system and the distillation unit. The flushing medium, for example nitrogen, serves for rendering inert within the reaction unit, reduces the risk of explosion and, as a carrier gas, supports the separation of final products produced during operation of the device.

Fans are advantageously provided inside a wall of the air guide housing, in which the cooling section of the distillation unit can be arranged, for the targeted conduction of ambient air over the cooling section. The air guide housing with the fans is formed as a device for forcibly cooling the cooling section of the distillation unit with ambient air. The fans are connected to the control device.

The fans formed within the wall of the air guide housing of the cooling section of the distillation unit for the targeted conduction of ambient air over the cooling section are preferably arranged on an upper side, in particular on an end face pointing upwards in the vertical direction, or on a side face of the air guide housing.

An advantage of the invention is that the extraction device for extracting gases from the reaction unit and generating a negative pressure within the reaction unit is arranged downstream of an oil tank arranged downstream of the distillation unit in the flow direction of the gases. Thus, the negative pressure is also generated within the distillation unit.

According to a further preferred embodiment of the invention, the heating system has a head element and the jacket element, which is firmly connected to the head element, as well as support elements. The head element is mounted on the support elements which can be varied in length in the vertical direction. By changing the length of the support elements between two end positions, the heating system is opened and closed in the vertical movement direction.

In this case, the heating system preferably has two support elements which are preferably arranged on both sides of the heating system. According to a first alternative, the support elements are driven by electric spindles. According to a second alternative, the support elements are formed as hydraulic supports.

According to a further development of the invention, the jacket element is formed with a hollow cylindrical wall. The wall is open in the vertical direction downwards and closed at the top with a circular hood. The jacket element is connected to the head element at the hood to form a unit.

The jacket element advantageously has heating elements distributed uniformly around the circumference of the inner surface of the wall. To prevent heat transfer to the outside, the wall is formed with a heat insulation made of ceramic powder.

According to a further advantageous embodiment of the invention, the hood is formed at the centre point with an exhaust gas port as a connection to an exhaust gas line of the heating system. The exhaust gas line extends from the exhaust gas port through the hood into the head element of the heating system.

The exhaust line advantageously has a connecting element at the distal end to the exhaust gas port of the hood as a connection to the exhaust gas line of the distillation unit.

The exhaust gas line extending from the exhaust gas port through the hood into the head element of the heating system can be formed in the region of the exhaust gas port for compensating thermal expansions with a tube connection which is automatically variable in length, in particular in the vertical direction.

According to the invention, the reaction unit is formed with a wall in the form of a hollow cylindrical vessel which is closed at the bottom. The open side of the wall can be closed by means of a cover element.

A high-temperature-resistant seal is advantageously arranged between the wall and the cover element.

The cover element of the reaction unit is preferably formed to be circular and has the exhaust gas port at the centre point. It is particularly advantageous that the exhaust gas port of the cover element and the exhaust gas port of the jacket element engage in one another in the closed state of the heating system and form a tight connection to the exhaust gas line.

According to the invention, the cover element of the reaction unit is formed with a connecting port for connection to a device for introducing a gaseous flushing medium, in particular nitrogen, into the reaction unit.

The reaction unit can have screen elements inside, which are preferably aligned horizontally and arranged at different heights, at a distance from one another. The screen elements preferably cover the entire cross-section of the reaction unit.

The control device of the device for the material treatment of raw materials serves to control a method for operating the device according to the concept and, in addition to the temperature sensors, the device for forced cooling, in particular the conveying devices, such as the fans for directing ambient air in a targeted manner over the cooling section or at least one pump for conveying the liquid heat transfer fluid, and the extraction device, is advantageously also connected to a drive of the support elements, a filling level sensor of the oil tank, a pressure sensor and valves of heating circuits of the heating system. The filling level sensor of the oil tank can be formed as a float. The pressure sensor is advantageously arranged in the region of the oil tank. The control device can also be connected to an oil conveying device for extracting the oil of the oil tank, in particular a piston pump. The oil conveying device is put into operation upon a signal sent by the filling level sensor of the oil tank to the control device, and oil is conveyed out of the oil tank.

The object is also achieved by a method according to the invention for operating the device for the material treatment of carbon-containing raw materials. The method has the following steps:
charging a reaction unit with raw materials,
preheating the reaction unit,
opening a heating system and introducing the reaction unit into the heating system, in particular onto a bottom element of the heating system,
closing the heating system so that the reaction unit is arranged in a closed space,
heating the reaction unit and starting a charring and distillation process, wherein the charring and distillation process is carried out by selective heating at a substantially constant reaction temperature within the reaction unit, wherein the temperature is determined,
removing any developing gases from the reaction unit to a distillation unit by means of an exhaust gas line formed between the reaction unit and the distillation unit and determining the temperature of the gas flowing through the exhaust gas line,
cooling and condensing the gases in the distillation unit, wherein the temperature of the gases is controlled by forced cooling of a cooling section of the distillation unit by means of a heat output dissipated by the gases,
introducing the distillation products into an oil tank and discharging oil,
extracting non-condensable gases from the oil tank, wherein a negative pressure to the environment is generated within the reaction unit and oxygen is removed from the reaction unit,
opening the heating system and removing the reaction unit from the heating system,
cooling the reaction unit, removing the final products from the reaction unit, wherein during the procedure of removing the final products from the reaction unit a gaseous flushing medium, especially nitrogen, is applied to the reaction unit, and separating the final products, and
removing the final products from the oil tank.

Targeted heating is understood to mean that the reaction unit arranged within the heating system is heated during the charring and distillation process in such a way that the reaction temperature within the reaction unit, also referred to as the process temperature, is substantially constant and varies only within a predetermined temperature band. In doing so, the reaction temperature is permanently monitored. The value of the temperature is transmitted to the control device, which controls the opening and closing of the valves of heating circuits of the heating system and thus a firing in accordance with a predetermined desired value of the temperature.

When the heating system is closed, an exhaust gas port of the reaction unit is preferably coupled to an exhaust gas port of an exhaust gas line of the heating system, and the exhaust gas line of the heating system and an exhaust gas line of the distillation unit are coupled to one another on a connecting element, so that a gas-tight connection is produced from the reaction unit to the distillation unit. The heating system is advantageously opened and closed by extending and retracting support elements.

According to a further development of the invention, with the extraction of non-condensable gases from the oil tank and thus the generation of the negative pressure, the absolute value of the pressure within the reaction unit can be set in the range from 2 mbar to 10 mbar, in particular from about 4 mbar.

In order to cool and condense the gases in the distillation unit, ambient air can be passed in a targeted manner over the cooling section of the distillation unit, or a liquid heat transfer fluid, in particular water as coolant, can flow through the cooling section.

According to an advantageous embodiment of the invention, during the procedure of cooling and condensing the gases in the distillation unit, the temperature of the gases is adjusted to a value in a range from 95° C. to 125° C., in particular via a volume flow of the ambient air or an output of the fans or a mass flow of a heat carrier fluid. The volume flow of the ambient air or the mass flow of the heat transfer fluid ensures the heat to be dissipated from the cooling section and cools the cooling section. The temperature of the gases is determined in the exhaust line formed between the heating system and the distillation unit, in particular the at least one temperature sensor for determining the temperature of exhaust gases discharged from the heating system.

An advantage of the invention is that during the charring and distillation process, an exhaust gas line formed between the reaction unit and the distillation unit is heated, in particular to a temperature in the range from 120° C. to 160° C., in particular in order to avoid premature condensation of the exhaust gas before entry into the distillation unit and consequently clogging of the exhaust gas line.

The reaction unit is preferably removed from the heating system at a temperature of the gas flowing through the exhaust gas line of about 60° C.

According to the invention, during the charring and distillation process respectively during the procedure of cooling the reaction unit, a gaseous flushing medium, in particular nitrogen, is introduced into the reaction unit. The rinsing preferably takes place in each case at time intervals, in particular in order to remove relatively high molecular weight gases from the reaction unit. Flushing by means of inert gas, such as nitrogen, removes undesirable components, such as polyaromatic constituents of polybutadiene or plasticisers, from the reaction unit, in particular during the charring and distillation process. Extraction of non-condensable gases and thus the generation of the negative pressure within the reaction unit and the inflow of the flushing medium into the reaction unit advantageously take place offset in time with respect to one another. Specifically during the procedure of cooling the reaction unit, the flushing medium can be periodically introduced into the reaction unit for a duration in the range of two to three minutes.

After the reaction unit has cooled, the reaction unit is preferably opened at a temperature inside the reaction unit in the range from 20° C. to 60° C., in particular in the range from 30° C. to 60° C., for removing the final products. During the procedure of removing the final products from the reaction unit, carbon can be extracted as the final product.

According to a further development of the invention, extracted non-condensable gases are fed to the heating system for combustion within the heating system and thus for heating the reaction unit, and/or to a combined heat and power station for generating thermal energy and electric energy.

The method is preferably operated with at least four reaction units simultaneously and in a modular manner with the following steps:
charging a first reaction unit, while a second reaction unit, which is already charged, is preheated,
feeding a third, charged and preheated reaction unit to the heating system and heating the reaction unit in order to carry out the charring and distillation process; and
cooling and emptying a fourth reaction unit in which the charring and distillation process is completed.

According to a further development of the invention, the reaction unit is charged with raw materials of a mass in the range from 2.5 t to 3 t. The reaction unit advantageously remains in the heating system for a period of about 2.5 h to 3.5 h. The reaction temperature within the reaction unit is preferably between 350° C. and 800° C., in particular 550° C.

The energy consumption for a process run with a reaction unit equipped in particular with used tyres amounts to 60 kWh to 80 kWh. A number of twelve reaction units and nine passes per day results in a daily energy demand of 6,480 kWh to 8,640 kWh. With an average of 223 production days per year, the annual energy demand is therefore 1.445 MWh to 1.927 MWh. By contrast, the values of the generated energy for electricity and heat are each about 10.5 MWh per year.

The method according to the invention is based on a charring/distillation process, so that the device according to the invention is an industrial charring/distillation module, also referred to as a VDI module.

In order to carry out the method effectively, the device was based on the design with modules in order to thus optimise or maximise the throughput and to be able to adapt it to the current demand.

Further advantages of the device according to the invention and the method according to the invention compared to the prior art can be summarised as follows:
no pre-sorting of raw materials,
treatment of raw materials, in particular of
   waste rubber products, such as used tyres, rubberised chain links, steel rope-reinforced rubber belts and conveyor belts, wherein the products, in order to obtain their structure, are treatable in their substantially initial form, i.e., for example, neither crushed nor shredded, and thus not crushed, or compacted,
   organic and renewable raw materials, such as wood in all forms, in particular beech and oak, bamboo and peel and fruit, such as coconut peel and orange peel,
   animal waste, such as bones and carcasses,
   contaminated carbon,
   contaminated soils or other materials, for example after oil spills,
   substantially uncrushed or undismantled and thus complete end-of-life vehicles; and
   carbon composite materials, in particular with carbon fibres, especially from the automotive industry,
ecological, economic and carbon dioxide-free and thus sustainable technology with very low energy consumption.

The various method parameters, such as the temperatures and the duration of the process and the flushing with gaseous flushing medium, and associated therewith the performances of individual components, such as the heating system, the conveying devices of the device for forced cooling of the distillation unit, such as the fans or the at least one pump, and the extraction device, are dependent on the raw materials to be treated within the reaction unit. Thus, the methods or devices with the corresponding control programs stored in the control device can be distinguished as follows:
a) device and method for the material treatment of tyres,
b) device and method for the material treatment of rubberised chain links,
c) device and method for the material treatment of conveyor belts,
d) device and method for the material treatment of complete vehicles or crushed vehicles of the automotive industry,
e) device and method for the material treatment of renewable raw materials such as wood and bamboo, and biowaste such as coconut shells and orange shells,
f) device and method for the material treatment of animal waste,
g) device and method for the material treatment of bitumen or asphalt,
h) device and method for the material treatment of energy storages, in particular batteries, especially from the automotive industry,
i) device and method for the material treatment of electronic components such as computers, mobile phones, laptops and smartphones, and
j) device and method for the physical treatment of contaminated carbon and soils contaminated with pollutants for reactivating carbon.

Depending on the raw materials to be treated, the raw materials are advantageously mixed in certain ratios with respect to one another within the reaction unit, for example tyres and batteries, in order to influence method parameters or final products.

| | Raw | | | | | | |
|---|---|---|---|---|---|---|---|
| | material/ | E-block | E-block | E-scrap | Smart | Smart | waste |
| | mg/kg | 36 kg^{1, 2, 3} | 500 kg^{1, 2, 3} | 515 kg^{1, 2, 3} | coarse^{1.2.3} | fine^{1, 2, 3} | tyres^{1.2.3} |
| Ag | silver | <1 | <5 | 600 | <1 | <1 | <1 |
| Al | aluminium | 106.000 | 120.000 | 73.000 | 8.300 | 7.500 | 2.500 |
| As | arsenic | <1 | <5 | 140 | <2 | <2 | <1 |
| Ba | barium | 19 | 9 | 2.000 | 54.000 | 40.000 | 18 |
| Be | beryllium | <1 | 10 | 91 | <1 | <1 | — |
| Bi | bismuth | <4 | <16 | 510 | 16 | 42 | <1 |
| Ca | calcium | 1.400 | 1.600 | 11.000 | 45.000 | 40.000 | 6.900 |
| Cd | cadmium | <1 | <2 | 51 | <1 | <1 | 1 |
| Co | cobalt | 54.000 | 60.000 | 36.000 | 83 | 110 | 108 |
| Cr | chromium | 74 | 69 | 15.000 | 190 | 230 | <1 |
| Cu | copper | 103.000 | 110.000 | 102.000 | 560 | 570 | 33 |
| Fe | iron | 28.000 | 17.000 | 122.000 | 6.500 | 6.300 | 364 |
| Ga | gallium | <21 | <28 | 240 | <2 | <2 | <1 |
| Ge | germanium | <6 | 260 | 350 | <1 | <1 | <1 |
| Hf | hafnium | <2 | <9 | 76 | <1 | <1 | — |
| In | indium | 90 | <106 | 150 | <5 | <5 | — |
| K | potassium | <38 | <86 | 350 | 1.300 | 1.200 | 1.210 |
| Li | lithium | 30.000 | 33.000 | 7.800 | 7 | 10 | 10 |
| Mg | magnesium | 710 | 990 | 5.600 | 35.000 | 34.000 | 850 |
| Mn | manganese | 46.000 | 50.000 | 12.000 | 140 | 110 | 2 |
| Mo | molybdenum | <1 | <4 | 190 | 7 | 3 | 4 |
| Na | sodium | 180 | <14 | 1.900 | 1.500 | 2.600 | 1.300 |
| Nb | niobium | <3 | <11 | 230 | <2 | <2 | — |
| Ni | nickel | 137.000 | 150.000 | 14.000 | 190 | 180 | <1 |
| P | phosphorus | 5.300 | 6.900 | 2.800 | 500 | 800 | 364 |
| Pb | lead | 16 | <10 | 310 | 62 | 150 | 28 |
| Re | rhenium | <1 | <6 | 130 | <1 | <1 | — |
| S | sulphur | — | — | 2.600 | 24.000 | 22.000 | 25.500 |
| Si | silicon | — | — | 27.000 | 67.000 | 63.000 | 43.500 |
| Sb | antimony | <2 | <9 | 150 | 170 | 160 | — |
| Se | selenium | <9 | <46 | 89 | <1 | <1 | — |
| Sn | tin | 110 | 160 | 5.300 | 110 | 120 | 2 |
| Sr | strontium | 8 | 31 | 2.500 | 790 | 650 | 6 |
| Ta | tantalum | <5 | <9 | 1.400 | <3 | <3 | — |
| Ti | titanium | 240 | 280 | 1.500 | 3.200 | 3.100 | 208 |
| Tl | thallium | — | <15 | 180 | <14 | <14 | <1 |
| V | vanadium | <5 | <3 | 190 | 14 | 15 | 6 |
| Zn | zinc | 250 | 300 | 4.700 | 14.000 | 17.000 | 39.500 |
| Zr | zirconium | 36 | 55 | 680 | 16 | 12 | — |
| C | carbon | 29.1% | 29.5% | 10.2% | 49.7% | 49.3% | |

¹Ground to particle-size <0.1 mm - results head space GC-MS screening and thermogravimetry results
²Thermogravimetry TGA, results GC-MS screening
³Trace elements using ICP OES according to HN03/HF acid digestion - SOP 671 (679)

In the table above, the recovered raw materials are indicated in mg/kg. The third and fourth columns list the raw materials according to a device and a method according to h) and the fifth column lists the raw materials according to a device and a method according to i), while the sixth and seventh columns list the raw materials according to a device and a method according to d) and the eighth column lists the raw materials according to a device and a method according to a).

In the method according to h), the raw materials of which are listed in the fourth column of the table, battery blocks, also referred to as energy blocks, from the automotive industry with a mass of 500 kg and used tyres with a mass of about 500 kg were used as starting material. Prior to the process, the steel sheaths including screws with a mass of about 60 kg were removed from the battery blocks and the remaining 440 kg of starting material were layered onto a separate screen in order to avoid mixing the battery blocks with the used tyres within the reaction unit. The residues of the processed battery blocks removed from the reaction unit after the end of the completed process had a mass of 220.9 kg and were shredded to a uniform size in the range from 0.2 mm to 0.5 mm for further analysis. From the analytical data presented in the table, it appears that all inorganic or metallic components of the battery blocks are detected at a recovery rate above 98.5%. The metals and inorganic components, such as cobalt, nickel, magnesium, copper, niobium and lithium, can be recovered by proven metal refining.

In the case of the method according to (i), the raw materials of which are listed in the fifth column of the table, the starting material used was electronic waste, such as televisions, drills and cables, with a mass of 500 kg, electronic scrap, such as computers in the form of laptops and mobile phones, with a mass of 15 kg, and used tyres with a mass of approximately 500 kg. The computers and mobile phones were placed separately in a metal box in the reaction unit in order to avoid mixing with the other starting materials. The residues of the processed computers and mobile phones removed from the metal box after the end of the completed process had a fixed mass of 7.7 kg and were shredded to a uniform size in the range from 0.1 mm for further analysis. Optical emission analysis revealed a high recovery rate of the metals, such as cobalt, chromium, lithium, nickel, cadmium, tantalum, gallium, germanium, manganese, rhenium, strontium and zirconium, which are to be recovered by proven metal refining. A recovery rate or recycling rate of 98% is observed.

In the method according to (d), the raw materials of which are listed in the sixth column of the table, a complete Smart vehicle with a mass of 750 kg was used as the starting material for the process. Before the process, only the liquids, such as the cooling fluid and the brake fluid, the engine oil and the petrol, as well as the battery were removed. The solid residues of the processed complete vehicle removed from the reaction unit after the end of the completed process had a mass of 450 kg. The mass was composed of 30% carbon and 70% metals, such as steel, spring steel and precious metals. In addition, about 250 kg to 270 kg of light oil were recovered. The proportion of residual gas was about 6% to 8%. This results in a recovery rate or utilisation rate of 95%.

In the case of samples of rapeseed, unground or ground, the method according to DIN/EN 12879 determines carbon contents between 98.8% and 99.8%, while with the same method, in the case of samples of rapeseed pellets for carbon black, carbon contents in the range from 79.7% to 81.0% are determined, in the case of samples of plastic bottles, a carbon content of 99.1% is determined, in the case of samples of oak wood, a carbon content of 98.5% is determined, in the case of samples of industrial waste, a carbon content of 99.4% is determined and in the case of rubber waste, a carbon content of 99.4% is determined. For samples of rapeseed pellets for oil, a carbon content of 99.5% is determined.

The carbon/hydrogen and nitrogen content according to ASTM D5291 and the oxygen content according to a method based on ASTM D5622 are in each case determined with VARIO EL Cube of Elementar, the fluorine content and the chlorine content are determined by means of pyrolysis ion chromatography with the Analytik Jena combustion module, absorption module 920 or ion chromatograph 930 Compact IC Flex.

Vaporisable fractions up to 200° C. are determined by means of Head space GC-MS screening with Trace GC Ultra in connection with Thermo Scientific's DSQ II mass spectrometer.

Hydrofluoric acid and nitric acid are determined by microwave digestion for ICP OES with Ofen Model StarT from MWS Gmbh, while trace elements, in particular inorganic fractions, are determined by means of ICP OES with ICP OES Arcos from Spectro.

Thermogravimetric analyses are performed using Hi-Res TGA 2950 from TA Instruments.

Further significant advantages are that the steel-rubber composites which have hitherto only been separable with high energy expenditure can be separated without significant use of external energy. The resulting products can be returned to high-quality use in the spirit of an efficient circular economy, which helps to conserve resources. The resulting products include:
light oil, for example with a density of approximately 927 kg/m³ at 15° C., a viscosity of 4,74 mm²/s and a flash point below 21° C.,
gas,
metals, mainly steel or iron and titanium, and
amorphous, inorganic carbon or carbon agglomerates.

The amorphous, inorganic carbon produced by the method according to the invention for operating a device for the material treatment of carbon-containing raw materials has, according to the design, a structure of a three-dimensional arrangement of carbon nanoparticles as agglomerates and, depending on the starting raw materials, advantageously a degree of purity in the range from 95% to 99.9%. The carbon nanoparticles are cross-linked without long-range order, do not exhibit any large-scale graphitic arrangement and are not arranged as nanotubes.

The carbon formed with the structure of three-dimensionally arranged nanoparticles is produced industrially by means of the device and the method according to the invention and thus has a significant economic advantage over carbons obtained or produced in the laboratory which are known from the prior art. The purity of the carbon is significantly influenced by the flushing with gaseous flushing medium, in particular during the charring and distillation process or the cooling of the reaction unit.

Depending on the starting raw materials, the carbon produced in the method for operating the device for the material treatment of raw materials has a BET surface area determined by the method according to DIN ISO 9277 of greater than 2,500 m²/g BET, in particular up to 9,500 m²/g BET, specifically greater than 3,500 m²/g BET or greater than 4,000 m²/g BET, in particular in the range from 4,200 m²/g BET to 4.500 m²/g BET and thus a very high adsorption capacity without release of substances to the environment. The environment is thus not polluted, for example by leaching.

The carbon produced by the method according to the invention preferably has a density of about 66 kg/m³ and can advantageously be designed with a greater tensile strength than alloyed steel.

The carbon obtained in this way can have an electric conductivity in the range from 4.5·10⁷ Ωm to 5.8·10⁷ Ωm. The electric conductivity is determined by the method according to DIN EN ISO 15091.

The carbon produced in the method according to the invention for operating the device for the material treatment of raw materials is not soluble in concentrated or dilute cold acids, such as sulfuric acid, nitric acid, hydrochloric acid, and is not attacked by alkali solutions. Nitric acid is spontaneously decomposed into water and nitrous gases, which may indicate a catalytic effect. Neither polar organic solvents nor nonpolar solvents are capable of dissolving the carbon.

The recovered light oil is used, for example, in the chemical industry, in particular as a raw material for base chemicals, and in the pharmaceutical industry, for generating thermal energy and electric energy, for example by means of a CHP, while the gas can be used for generating thermal energy and electric energy, for example by means of a gas turbine and generator, or for recycling and use in the process. The recovered metals, such as steel, can be recycled to the steel industry, where the physical and chemical properties of metals can be maintained by very low process temperatures.

Further details, features and advantages of the invention will become apparent from the following description of exemplary embodiments with reference to the accompanying drawings. In the drawings:

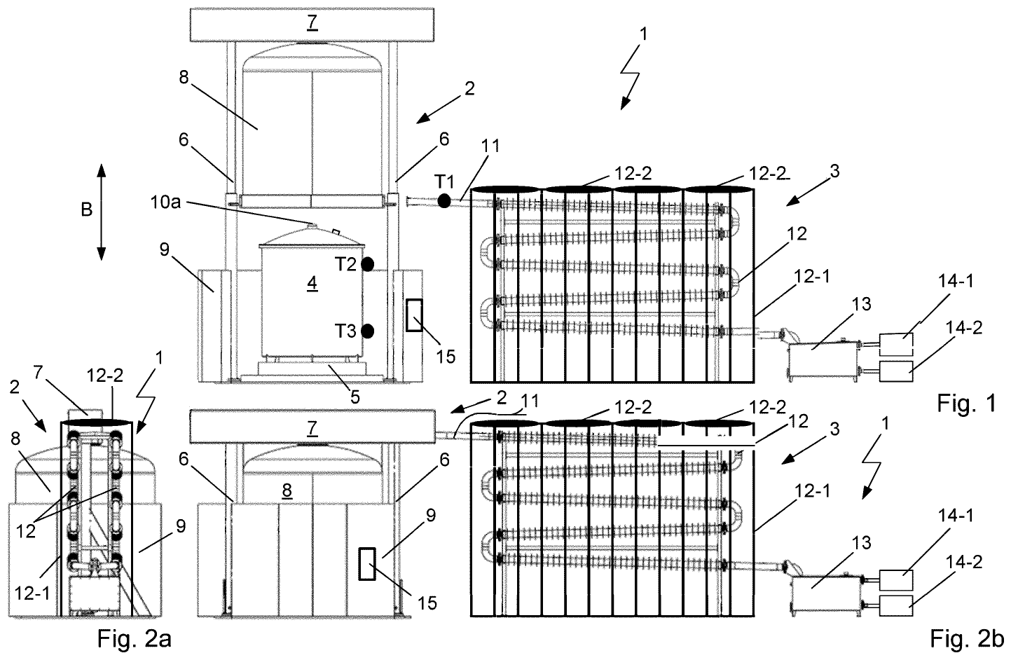

FIG. 1: industrial charring/distillation module as a device for the material treatment of raw materials in the open state in front view,

FIG. 2a: industrial charring/distillation module as a device for the material treatment of raw materials in the closed state in side view, and

FIG. 2b: in front view,

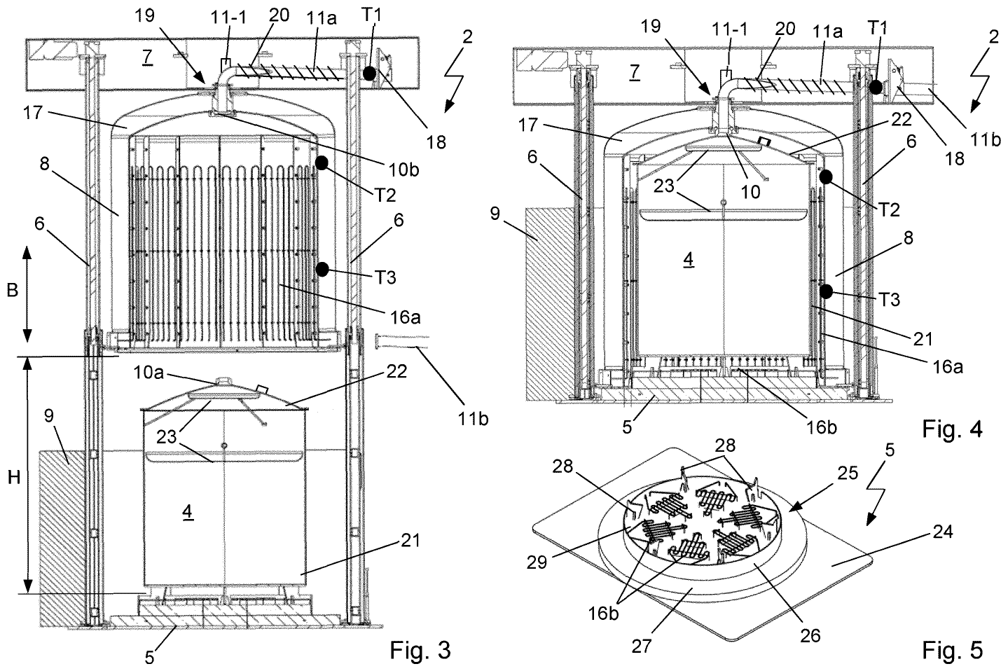

FIG. 3: sectional representation of the heating system in the opened condition,

FIG. 4: sectional representation of the heating system in the closed condition,

FIG. 5: bottom element of the heating system,

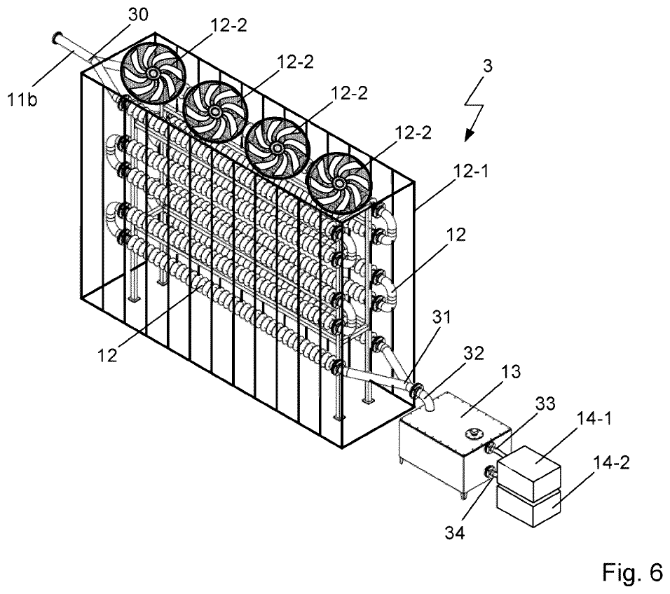

FIG. 6: distillation unit,

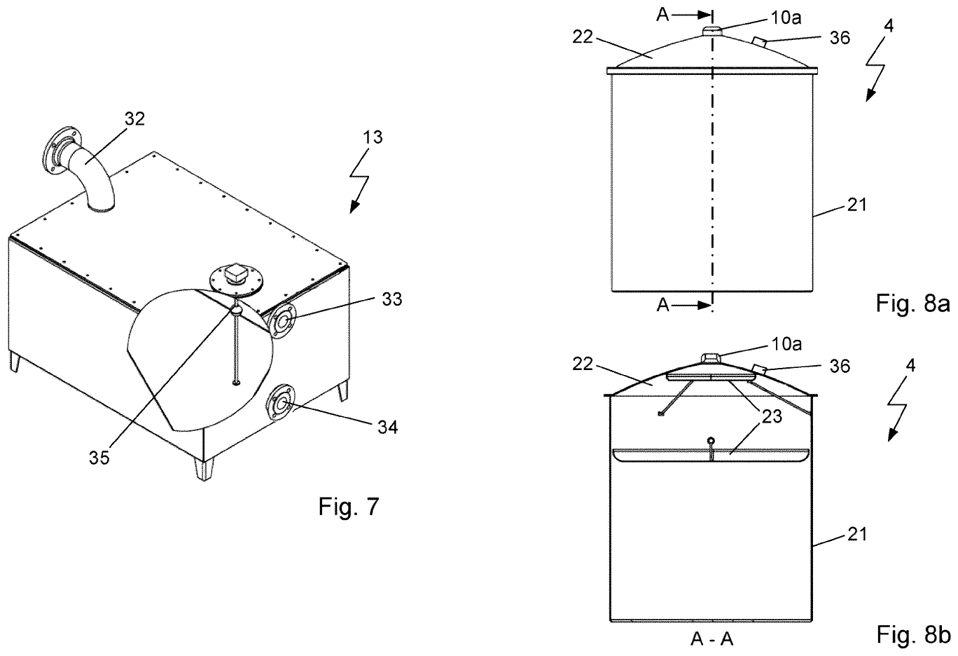

FIG. 7: oil tank, and

FIG. 8a: reaction unit in the closed state, and

FIG. 8b: sectional representation of the reaction unit in the closed state,

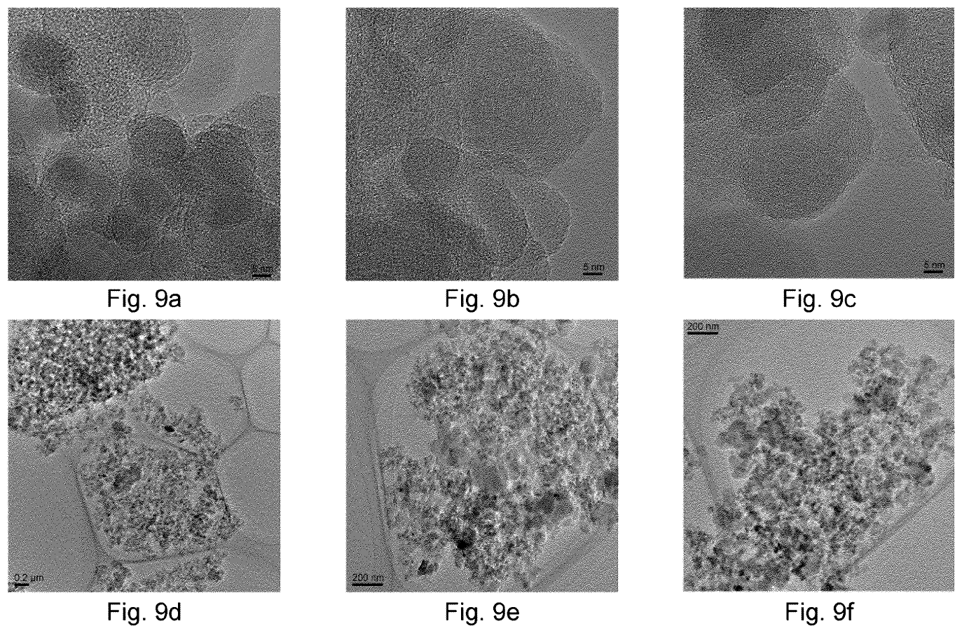

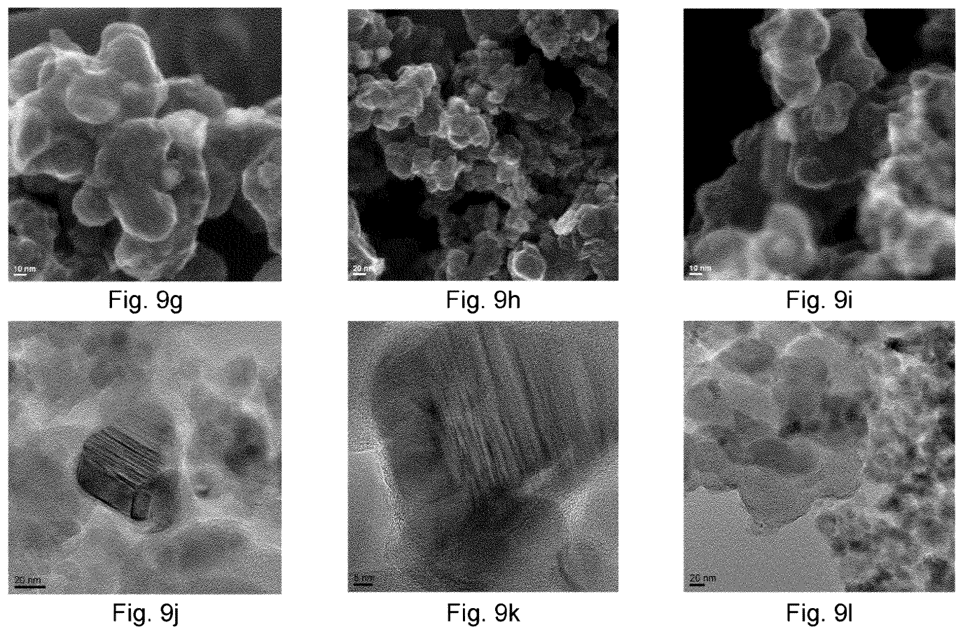

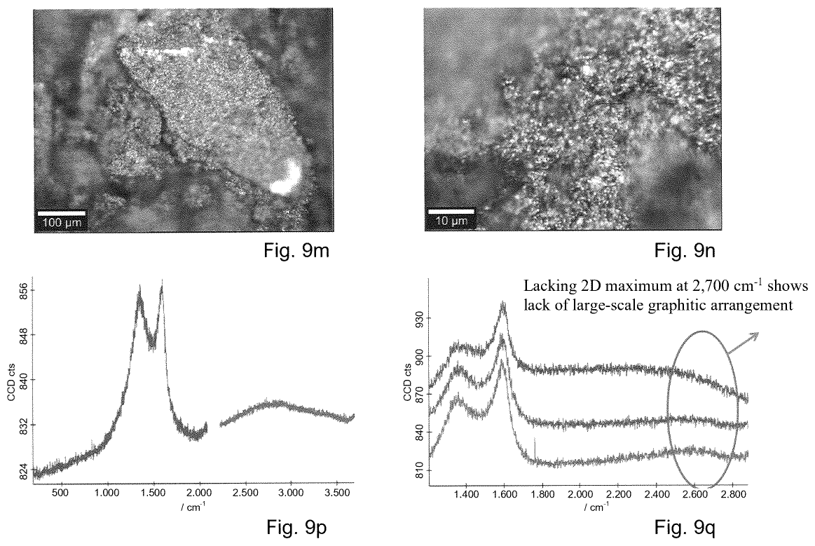

FIGS. 9a to 9n: microscopic images of carbon produced by the device for the material treatment of raw materials, and

FIGS. 9p and 9q: results of Raman spectroscopy of the carbon.

In FIGS. 1, 2a and 2b, an industrial charring/distillation module is represented as a device 1 for the material treatment of raw materials. FIG. 1 shows the device 1 in the open state in front view, while FIG. 2b shows the device 1 in the closed state in front view and FIG. 2a in side view.

The device 1 has a heating system 2 and a distillation unit 3. The reaction unit 4 charged with raw materials is preheated to a certain temperature in a non-represented preheating device and subsequently heated further in the heating system 2. The reaction unit 4 can be charged with a mixture of different raw materials, so that no pre-sorting of the products is necessary. After preheating, the reaction unit 4 is brought into the opened heating system 2 and positioned on the bottom element 5 of the heating system 2.

The head element 7 and the jacket element 8 of the heating system 2, which is firmly connected to the head element 7, are held movably in the movement direction B by means of support elements 6 arranged on both sides of the heating system 2. The support elements 6 are arranged at a distance of about 2.9 m from one another. The jacket element 8 has an outer diameter of about 2.5 m.

In the first end position according to FIG. 1, the support elements 6 are extended. Thus, the device 1 has a height of about 6.70 m. The head element 7 and the jacket element 8 open the space for equipping the heating system 2 with the reaction unit 4. The heating system 2 is opened. The reaction unit 4 can be introduced into the heating system 2 or removed from the heating system 2. The movement of the reaction unit 4 can advantageously take place by means of a rail system, not represented, on which the reaction unit 4 stands.

In the second end position according to FIGS. 2a, 2b, the support elements 6 are retracted. Thus, the device 1 has a height of about 3.70 m.

The jacket element 8 is seated on the bottom element 5 in such a way that the reaction unit 4 is positioned in a closed space. The heating system 2 is closed. The reaction unit 4 is surrounded at the bottom by the bottom element 5 and at the side surface and at the top by the jacket element 8.

The device 1 has temperature sensors T1, T2, T3 in the region of the heating system 2 and the distillation unit 3 for determining certain process temperatures. At least two temperature sensors T2, T3 are arranged in an intermediate space formed between the reaction unit 4 and the jacket element 8 in the closed state of the heating system 2. The temperature sensors T2, T3 are positioned, for example, from the inside of the jacket element 8 to project approximately 1 cm into the approximately 8 cm wide intermediate space. The temperature sensors T2, T3 are arranged at a vertical distance from one another in order to determine local temperature values or an average temperature within the intermediate space. The temperature within the reaction unit 4 is determined with the temperature values determined via the temperature sensors T2, T3.

The heating system 2 has an enclosure 9 in the lower region. The enclosure 9 enclosing the bottom element 5 and the side surfaces of the jacket element 8 in the closed state of the heating system 2 is opened for the purpose of equipping the heating system 2.

The gases produced in the charring process are discharged from the heating system 2 through the provided exhaust gas line 11 and are cooled down in terms of process technology. The gases are passed to the distillation unit 3 through the exhaust gas port 10a formed at the uppermost point of the reaction unit 4 and through the exhaust gas line 11 arranged in the head element 7. Subsequently, the gases flow through the cooling section 12 of the distillation unit 3. The cooling section 12 is formed from tubes according to FIGS. 1, 2a, 2b. The tubes inclined to the horizontal are provided with ribs in order to increase the heat transfer surface and thus to improve the heat transfer. The heat is transferred from the gases to the ambient air.

In order to further increase the heat output to be transferred from the gases to be cooled to the ambient air and, specifically, to improve the control of the temperature of the gases flowing through the cooling section 12 of the distillation unit 3, the cooling section 12 is surrounded by an air guide housing 12-1. Fans 12-2 are arranged on the upper side, in particular on the end face of the air guide housing 12-1 pointing upwards in the vertical direction, which fans draw in the ambient air as cooling air uniformly through the air guide housing 12-1. Alternatively, the fans can also be formed on a side surface of the air guide housing 12-1. In this case, the ambient air is directed in a targeted manner over the cooling section 12. A further temperature sensor T1 is arranged on the exhaust gas line 11 formed between the heating system 2 and the distillation unit 3 in order to determine the temperature of the exhaust gases discharged from the heating system 2.

According to an alternative embodiment, the gases within the cooling section can also be cooled with a heat transfer fluid other than air, for example water. In this case, instead of tubes, the cooling section is formed with ribs of coaxial tubes formed on the outer jacket surface. The gases flow in the interior of the inner tube, while the preferably liquid heat transfer fluid is passed through in the intermediate space between the outside of the inner tube and the inside of the outer tube.

The cooling section 12 is formed with two tubes aligned parallel to one another. The gases are divided into two partial mass flows before entering the cooling section 12 and are mixed again after flowing through the cooling section 12.

Subsequently, the distillation products are introduced into an oil tank 13. In the oil tank 13, the oil obtained from the charring process and the subsequent distillation, which in its consistency and composition corresponds to a light oil or is very similar to the intermediates of crude oil processing, settles. The non-condensable portion of the gas is discharged from the oil tank 13. The oil tank 13, with a capacity of about 1,000 litres, also serves as an expansion vessel of the device 1.

An extraction device 14-1, in particular a pump, specifically a diaphragm pump, for extracting the gases via the surface of the oil accumulating within the oil tank 13, and an oil conveying device 14-2, in particular a pump, specifically a piston pump, for conveying the oil from the oil tank 13, are arranged on the oil tank 13. When the gases are extracted, a negative pressure is generated within the cooling section 12 of the distillation unit 3, the exhaust gas line 11 and specifically within the reaction unit 4. With the extraction device 14-1, the air and thus the oxygen as a constituent of the air are also purposefully extracted of the reaction unit 4. A vacuum can thus be generated within the reaction unit 4.

The gases extracted above the surface of the oil accumulating inside the oil tank 13 can be used directly with a combined heat and power station, referred to as a CHP, for generating thermal energy and electric energy.

The device 1 is also formed with a control device 15 for controlling the method for operating the device 1. The control device 15 determines and indicates, for example, the filling level within the oil tank 13, the flow of oil or gas and a possible defect in a line of the device 1. The control device 15 is connected to corresponding sensors. The temperature sensors T1, T2, T3 are also coupled to the control device 15. The values determined with the temperature sensors T1, T2, T3 serve to control the device 1, in particular the heating system 2 and thus to heat the reaction unit 4 and the fans 12-2 of the cooling section 12 and the extraction device 14-1. The control device 15 can be used, inter alia, to indicate the status of different heating circuits of the heating system 2 and process temperatures. The arrangement of the jacket element 8 of the heating system 2 can also be determined and represented in the open, closed and partially open states. Consequently, the control device 15 also serves to extend and retract the support elements 6 for opening and closing the heating system 2.

FIGS. 3 and 4 each show a sectional representation of the heating system 2.

FIG. 3 represents the heating system 2 in the opened state and FIG. 4 in the closed state.

According to FIG. 3, the support elements 6 are fully extended. The head element 7 arranged at the upper ends of the support elements 6 and the jacket element 8 firmly connected to the head element 7 are arranged at a height H above the bottom element 5, so that the reaction unit 4 can be freely moved in the horizontal direction between the bottom element 5 and the jacket element 8.

The casing element 8 is supported movably in the lower region against the support elements 6. By means of the lateral support against the support elements 6, a straight movement of the casing element 8 in the movement direction B between the end positions is ensured. Canting of the casing element 8 is avoided.

The jacket element 8 has heating elements 16a distributed uniformly on the circumference of the inner surface of the jacket. The heating elements 16a are arranged substantially in the vertical direction and are guided through the wall to the inner surface in the lower region of the jacket element 8. The heating elements 16a are each formed from two vertically aligned sections which are connected to one another at the upper end by means of a deflection.

The jacket element 8, which is open downwards in the vertical direction, is closed at the top by a hood 17 and fastened to the head element 7. The head element 7 and the jacket element 8 form a coherent unit. The hood 17 is formed at the centre point with an exhaust gas port 10b as a connection to the exhaust gas line 11a. The exhaust gas line 11a extends from the exhaust gas port 10b through the hood 17 into the head element 7. The passage of the exhaust gas line 11a through the hood 17 is sealed off from the hood 17. The exhaust gas line 11a is formed in the region of the exhaust gas port 10b with a pipe connection 19 which can vary in length in the vertical direction, for example in the form of a telescopic pipe. The tube connection 19, which is automatically adjustable in length, serves to compensate for thermal expansions of the reaction unit 4, in particular with respect to the jacket element 8 with the hood 17 of the heating system 2.

The exhaust gas line 11a is formed as a transition from the reaction unit 4 to the distillation unit 3 with a heating device 20. The electrically operated heating device 20 surrounding the exhaust gas line 11a is connected to the control device 15, as is the temperature sensor T1.

In addition, the exhaust gas line 11a has a connecting element 11-1 for connecting the exhaust gas line 11a to a device for admitting a gaseous flushing medium, for example nitrogen. The flushing medium can flow into the exhaust gas line 11a and in particular into the reaction unit 4 via the connecting element 11-1. The connecting element 11-1 is arranged between the pipe connection 19 and the region of the exhaust gas line 11a which is enclosed by the heating device 20, especially at the highest point of the exhaust gas line 11, 11a in the vertical direction.

The exhaust gas line 11a has a connecting element 18 at the distal end, starting from the exhaust gas port 10b. The connecting element 18, which is advantageously formed as a quick-connect coupling, serves to connect the exhaust gas line 11a of the heating system 2 to the exhaust gas line 11b of the distillation unit 3 in the closed state of the heating system 2 according to FIG. 4. As a result of the downward movement of the head element 7 when closing the heating system 2, the exhaust gas lines 11a, 11b on the connecting element 18 and the exhaust gas ports 10a, 10b are coupled to one another, so that a gas-tight connection is produced from the reaction unit 4 to the distillation unit 3.

The reaction unit 4 arranged on the bottom element 5 is formed with a wall 21 in the form of a hollow cylindrical vessel with an outer diameter of approximately 1.8 m, which is closed at the bottom. The open side of the wall 21 can be closed by means of a cover element 22. A seal is arranged between the wall 21 and the cover element 22, so that the reaction unit 4 is tightly closed. Screen elements 23 are formed in the interior of the reaction unit 4. The screen elements 23 are aligned in the horizontal direction and are arranged at different heights, spaced apart from one another.

In the second end position shown in FIG. 4, the support elements 6 are fully retracted. The jacket element 8 is seated on the bottom element 5 and completely encloses the reaction unit 4. The heating system 2 is closed. The reaction unit 4 charged with raw materials is advantageously heated uniformly over the bottom and the wall 21. The heating elements 16a are used for heating via the wall 21, while heating elements 16b arranged on the bottom element 5 supply heat through the bottom to the reaction unit 4. In the closed state of the heating system 2, the heating elements 16a formed on the circumference of the jacket element 8 have equal distances from the wall 21 of the reaction unit 4. The heating elements 16a, 16b are preferably electrically operated.

The reaction unit 4 remains in the heating system 2 for a period of about 2.5 h to 3.5 h in which the main reaction and conversion of the raw materials takes place within the reaction unit 4. The reaction temperature within the reaction unit 4 is between 350° C. and 800° C., in particular between 400° C. and 600° C., specifically about 550° C., depending on the feed and depending on the final products to be produced. This temperature is determined by means of the temperature sensors T2, T3 arranged between the reaction unit 4 and the jacket element 8. This consumes an energy in the range of 40 kWh per hour. The reaction unit 4 is charged with raw materials of a mass in the range from 2.5 t to 3 t.

The gases formed during the charring process are discharged, in particular extracted, into the exhaust gas line 11 through the exhaust gas port 10 arranged on the cover element 22. In the closed state of the heating system 2, the exhaust gas port 10a of the reaction unit 4 and the exhaust gas port 10b of the hood 17 of the jacket element 8 are connected to one another in a gas-tight manner. This ensures that no gases can escape into the intermediate space between reaction unit 4 and the jacket element 8.

Inside the reaction unit 4 there is a negative pressure with an absolute value in the range from 2 mbar to 10 mbar, specifically about 4 mbar, which is generated by the extraction device 14-1 arranged at a first outlet port of the oil tank 13 for extracting the gases via the surface of the oil accumulating within the oil tank 13. With the targeted extraction of the oxygen from the reaction unit 4, the reaction temperature or the process temperature within the reaction unit 4 is reached in a shorter time on the one hand. On the other hand, this influences the structure formation of the carbon as the final product. Another factor influencing the formation and purity of the carbon is the duration of the charring process. The longer the charring process takes place, the cleaner the carbon and can also be employed, depending on the starting materials, for medical purposes, for example. The carbon employed for medical purposes should be additionally purified, if necessary. Carbon recovered during a rather shorter charring process is preferably used, for example, as a filter material or in the construction industry.

Influencing factors on the formation and purity of the carbon also include the flushing of the reaction unit with the gaseous flushing medium, in particular nitrogen, during the charring and distillation process on the one hand and during the procedure of cooling the reaction unit 4 on the other hand.

By means of the heating device 20 surrounding the exhaust gas line 11a, the exhaust gas line 11a is heated, in particular to a temperature in the range from 120° C. to 160° C., in order to reduce the temperature difference between the exhaust gas line 11a and the exhaust gas flowing through the exhaust gas line 11a. The temperature of the exhaust gas flowing through is determined by means of the temperature sensor T1. The heating device 20 serves to prevent premature condensation of the exhaust gas prior to entry into the distillation unit 3 and thus also an undesired clogging of the exhaust gas line 11a. The heating of the exhaust gas line 11a supports the outflow of the exhaust gas from the reaction unit 4.

In FIG. 5, the bottom element 5 of the heating system 2 is represented. The bottom element 5 has a bottom plate 24 and a centring device 25 for the jacket element 8, heating elements 16b and support elements 28 for holding the reaction unit 4. The bottom element 5 is substantially formed from ceramic in order to ensure thermal insulation towards the outside, in particular towards the bottom. In combination with the thermal insulation of the jacket element 8, the heat loss of the heating system 2 is thus minimised.

The reaction unit 4 stands on the support elements 28 of the bottom plate 24. The support elements 28 are formed and arranged in such a way that the reaction unit 4 is aligned centrally with the bottom element 5 when it rests on the support elements 28.

The centring device 25 is formed in the form of a circular disk with a shoulder. Consequently, the disk has two regions with different diameters. The circular surface arranged between the regions serves as a sealing surface 27.

The outer circumference of the region of the disk with the smaller diameter is smaller than the inner circumference of the wall 21 of the reaction unit 4 or of the jacket element 8. In the closed state of the heating system 2, a gap is formed between a jacket surface 26 of the region of the disk with the smaller diameter and the inner side of the wall 21. The jacket element 8 stands on the sealing surface 27 of the bottom plate 24, so that the space enclosed by the jacket element 8 and the bottom plate 24 is tightly closed. Seals are arranged on the corresponding surfaces of the bottom plate 24 and of the jacket element 8 in order to seal the enclosed space. In addition, the jacket element 8 is pressed and held onto the sealing surface 27 of the bottom plate 24 with a pressure in the range from 1 bar to 2 bar.

Since the support elements 6 are also fastened to the bottom plate 24, the bottom plate 24 carries the entire heating system 2.

The heating elements 16b are arranged substantially in the horizontal direction, on a terminal surface 29 of the centring device 25 and guided vertically through the terminal surface 29. The heating elements 16b, which are curved in a meandering manner, each have the form of a hand with five fingers. The length of the fingers increases from the outside to the inside, so that the middle finger has the greatest length. The heating elements 16b are aligned symmetrically to one another, with the tips of the fingers pointing towards the centre point of the terminal surface 29.

The support elements 28, on which the reaction unit 4 stands, project in the vertical direction beyond the heating elements 16b, so that the bottom of the reaction unit 4, which stands on the support elements 28, is arranged above the heating elements 16b. The heating elements 16b each have the same distance from the bottom of the reaction unit 4, in order to ensure a uniform introduction of heat through the bottom of the reaction unit 4.

The centring device 25, the support elements 28 and the heating elements 16b are arranged concentrically around the centre point of the bottom plate 24.

FIG. 6 shows the distillation unit 3, having the exhaust gas line 11b, the cooling section 12 with the air guide housing 12-1 and the fans 12-2, and the oil tank 13 with the extraction device 14-1 and the oil conveying device 14-2 in the order of the flow direction of the final products.

The gases discharged from the heating system 2 are passed through the exhaust gas line 11b to the cooling sections 12, which are likewise formed from pipes. The gas mass flow at a branch 30 is divided into two partial mass flows by two tubes aligned parallel to one another. The division of the gas mass flow results in a better heat transfer from the gas mass flow to the environment in order to optimise the procedure of distillation or condensation.

In order to further improve the heat transfer, the tubes are formed with ribs in order to increase the heat transfer surfaces of the cooling sections 12. The heat output to be dissipated from the gases to be cooled, in particular the amount of condensation heat, is further increased and simultaneously controlled by the air guide housing 12-1 and the fans 12-2. The ambient air is sucked uniformly through the air guide housing 12-1 as cooling air and guided over the cooling sections 12 in a targeted manner. The corresponding power or the air volume flow of the fans 12-2 ensures that the exhaust gases flowing through the cooling section 12 of the distillation unit 3 can be liquefied at a condensation temperature in the range from 95° C. to 125° C. With the additional inflow of the cooling sections 12, the cooling sections 12 are cooled to a temperature below the condensation temperature of the gases or kept at the corresponding temperature level. With the heat output controlled in this way, a higher yield of oil is achieved with a lower yield of residual gas. The temperature is determined by means of the temperature sensor T1, according to FIG. 1, arranged on the exhaust gas line 11 formed between the heating system 2 and the distillation unit 3.

After flowing through the cooling sections 12, the partial mass flows divided up before entry into the cooling sections 12 are recombined at an opening point 31 and introduced from above into the oil tank 13 through an inlet port 32.

The oil, which has a greater density than the gas, is deposited in the oil tank 13. The non-condensable portion of the distillation products is removed in the upper region of the oil tank 13 through a first outlet port 33. For extracting the gases via the surface of the oil accumulating within the oil tank 13, the extraction device 14-1 is arranged at the first outlet port 33 of the oil tank 13. With the extraction of the gases and the thus generated negative pressure within the device 1, in particular the air and thus the oxygen as a constituent of the air is extracted from the reaction unit 4 and the charring process is influenced.

For conveying the oil from the oil tank 13, the oil conveying device 14-2 is arranged on a second outlet port 34 of the oil tank 13.

In FIG. 7, an oil tank 13 with a cut-open side surface is represented for viewing into the interior.

The inlet port 32 is arranged on the upper side of the oil tank 13 so that the distillation products flow into the oil tank 13 from above. The oil settles at the bottom of the oil tank 13, while the gases, which have lower densities in contrast to the oil, are concentrated above the oil level. The oil level in the oil tank 13 is determined and observed with a float 35. When a predetermined filling height is reached, the oil is removed from the oil tank 13 for further processing.

The gases accumulating in the upper region of the oil tank 13 are discharged through the first outlet port 33, in particular extracted by means of the extraction device 14-1, while the oil accumulating in the lower region of the oil tank 13 is extracted through the second outlet port 34, in particular by means of the oil conveying device 14-2.

In FIGS. 8a and 8b, the reaction unit 4 is represented in the closed state, wherein FIG. 8b shows a sectional view of the reaction unit 4.

The wall 21, which is in the form of a hollow cylindrical vessel and has a closed bottom, can be closed at the open side opposite the bottom by means of a cover element 22. During the procedure of closing the reaction unit 4, the cover element 22 is placed in the vertical direction on the upwardly directed end face of the wall 21. Due to its own weight, the cover element 22 is pressed against the end face of the wall 21 and bears releasably against the wall 21.

A high-temperature-resistant seal is arranged between the wall 21 and the cover element 22 for closing the reaction unit 4 in a tight manner. In the closed state, the reaction unit 4 has a height of about 2.4 m.

The cover element 22 is formed next to the exhaust gas port 10a with a connecting port 36. A device for introducing a gaseous flushing medium, in particular nitrogen, into the reaction unit 4 can be connected to the connecting port 36.

The actual charring/distillation process, in which the reaction unit 4 is arranged within the heating system 2 and is heated or is kept substantially at the desired reaction temperature, is terminated at a temperature of the exhaust gas of about 60° C. determined by the temperature sensor T1 arranged between the heating system 2 and the distillation unit 3. The reaction unit 4 is removed from the heating system 2 and has a temperature, for example, in the range from 500° C. to 600° C.

After removal from the heating system 2, the reaction unit 4 is cooled to the temperature defined as a function of the use of the product. The mixture located inside the reaction unit 4 is removed after the reaction unit 4 has been opened, i.e. after the cover element 22 has been removed. The reaction unit 4 is then fed back to the process and charged. The carbon-iron mixture is separated into its components.

The recovered unique carbon is further formed in the oxygen-free atmosphere without oxygen during the cooling procedure between 600° C. and 60° C. or 20° C. or 30° C. within the reaction unit 4. In this case, the gaseous flushing medium, in particular nitrogen, is flowed into the reaction unit 4 through the connecting port 36, which likewise influences the cooling procedure. Alternatively, the gaseous flushing medium can be introduced through the exhaust gas port 10a, to which the device for introducing the gaseous flushing medium can be connected, in particular if the connecting port 36 is not formed. The inflow of the flushing medium during the cooling procedure and thus before the emptying of the reaction unit 4 can accelerate the procedure of cooling, but serves above all for cleaning the final products and could thus also support the formation of the carbon recovered with the device 1. The flushing of the reaction unit 4 increases the purity of the final products, in particular of the carbon. Impurities are flushed out. The flushing medium flowing into the reaction unit 4 through the connecting port 36 is again discharged from the reaction unit 4 together with the impurities through the exhaust gas port 10a formed in the cover element 22. The reaction unit 4 is opened at a temperature inside the reaction unit 4 in the range from 20° C. to 60° C., in particular in the range from 30° C. to 60° C.

During the procedure of opening the reaction unit 4, the cover element 22 is raised in the vertical direction and removed from the reaction unit 4 in such a way that the reaction unit 4 can be emptied and subsequently charged again. The reaction unit 4 can also be charged with the flushing medium during the procedure of emptying in order to achieve a desired purity of the final products, in particular of the carbon. The carbon is preferably extracted during emptying of the reaction unit 4.

The charring/distillation process for the material treatment of the raw materials simultaneously involves four reaction units 4 made of high-temperature-resistant steel, each with a filling quantity in the range from 2.5 t to 3.5 t (75% mechanically, 25% automated). While the first reaction unit 4 is charged, the second reaction unit 4, which is already charged, is preheated. Meanwhile, the third reaction unit 4 is already fed to the heating system 2 and is heated so that the actual charring/distillation process takes place. Meanwhile, the fourth reaction unit 4 is cooled and subsequently emptied.

By using the modular system, for example with four reaction units 4, the throughput can be increased stepwise and flexibly adapted to the respective demand. The entire process takes place quasi-continuously.

In FIGS. 9a to 9n, microscopic images of carbon produced with the device 1 for the material treatment of raw materials are shown. A structure of the carbon can be seen from the images produced using a transmission electron microscope, referred to as TEM for short. Transmission electron microscopy is used to detect and characterise the structure and particle size of substances and substance mixtures in the nanometre range.

The images show a very finely divided, three-dimensional, homogeneous and pseudo-crystalline structure of the primary carbon particles in the subnanometre range with a very large inner surface. The carbon particles are partially recognisable as larger agglomerates with the same surface structure.

FIGS. 9p and 9q show results of a Raman spectroscopy of the carbon. The missing 2D maximum at 2,700 cm⁻¹ shows the absence of a large-scale graphitic arrangement. The carbon produced with the device 1 for the material treatment of raw materials is amorphous, inorganic carbon in which the nanoparticles are cross-linked without long-range order. The carbon is neither nanotubes nor structurally similar to graphene.

The images of a Raman spectrum as well as the determination of the intensity and width of G-Raman and D-Raman bands can be done with Confocal RAMAN Microscope in Via by Renishaw with 532 nm and 785 nm lasers.

### LIST OF REFERENCE NUMERALS

1 device for material treatment
2 heating system
3 distillation unit
4 reaction unit
5 bottom element of the heating system 2
6 support element
7 head element of the heating system 2
8 jacket element of the heating system 2
9 enclosure
10, 10a, 10b exhaust gas port
11, 11a, 11b exhaust gas line
11-1 connecting element of the exhaust gas line 11, 11a
12 cooling section of the distillation unit 3
12-1 air guide housing
12-2 fan
13 oil tank
14-1 extraction device
14-2 oil conveying device
15 control device
16a, 16b heating element
17 hood
18 connecting element of the exhaust gas line 11, 11a
19 tube connection
20 heating device
21 wall of the reaction unit 4
22 cover element
23 screen element
24 bottom plate
25 centring device for jacket element 8
26 jacket surface of centring device 25
27 sealing surface of centring device 25
28 support element for reaction unit 4
29 terminal surface
30 branch
31 opening point
32 inlet port of the oil tank 13
33 first outlet port of the oil tank 13
34 second outlet port of the oil tank 13
35 float
36 connecting port of the cover element 22
B movement direction of the heating system 2
H height
T1, T2, T3 temperature sensor

1.-36. (canceled)

37. A device for the material treatment of raw materials comprising:
a reaction unit configured to be charged with the raw materials, the reaction unit including:
a hollow cylindrical vessel which is closed at the bottom; and
an open side which can be closed by a cover element, the cover element including a connecting port for admitting a gaseous flushing medium into the reaction unit; and
a heating system that can be in an opened state in order to be charged with the reaction unit, or in a closed state;
a distillation unit including a cooling section including a device for forced cooling, wherein the cooling section is one of arranged inside an air guide housing for the targeted routing of ambient air over the cooling section, or formed from at least one coaxial tube for the conduction of gases inside an internal tube and for the conduction of a heat carrier fluid in the intermediate space between the outside of the internal tube and the inside of the external tube;
temperature sensors connected to a control device, wherein at least one temperature sensor is associated with the heating system and at least one temperature sensor is associated with the distillation unit;
an extraction device for extracting gases from the reaction unit and generating negative pressure inside the reaction unit, wherein the extraction device is connected to the control device; and
an exhaust gas line for discharging exhaust gases from the reaction unit, the exhaust gas line connecting reaction unit to the distillation unit and including a connecting element for connecting to a device for introducing a gaseous flushing medium into the reaction unit.

38. The device according to claim 37, wherein the temperature sensors include at least two temperature sensors for determining the temperature within the reaction unit that are arranged in an intermediate space formed between the reaction unit and a jacket element of the heating system when the heating system is in the closed state.

39. The device according to claim 37, wherein the exhaust gas line includes a heating device for heating the exhaust gas line, wherein the heating device is connected to the control device.

40. The device according to claim 37, wherein at least one of the temperature sensors is arranged on the exhaust gas line.

41. The device according to claim 37, further comprising fans for the targeted conduction of ambient air over the cooling section, the fans located inside a wall of the air guide housing and connected to the control device.

42. The device according to claim 41, wherein the fans are arranged on a side face of the air guide housing or on an upper side, the upper side being an end face pointing upwards in the vertical direction.

43. The device according to claim 37, wherein the extraction device is arranged downstream of an oil tank arranged downstream of the distillation unit in a flow direction of the gases.

44. The device according to claim 37, wherein the heating system includes:
a head element;
a jacket element connected to the head element; and
support elements which can be varied in length in a vertical direction, wherein the head element is configured to be held on the support elements in such a way that, by changing the length of the support elements between two end positions, the heating system transitions between the opened state and the closed state in the vertical direction.

45. The device according to claim 44, wherein the heating system has two support elements, wherein the support elements are arranged on both sides of the heating system.

46. The device according to claim 44, wherein the jacket element includes a hollow cylindrical wall which is formed such that it is, in the vertical direction, open at the bottom, closed at the top by a circular hood, and connected to the head element at the hood.

47. The device according to claim 46, wherein the hood includes an exhaust gas port at a center point of the hood, the exhaust gas port connected to the exhaust gas line, wherein the exhaust gas line extends from the exhaust gas port through the hood into the head element.

48. The device according to claim 47, wherein the exhaust gas line is formed in the region of the exhaust gas port of the hood with an automatically longitudinally variable tube connection for compensating for thermal expansions.

49. The device according to claim 47, wherein the cover element of the reaction unit is circular and has an exhaust gas port at a center point of the cover element, wherein the exhaust gas port of the cover element and the exhaust gas port of the jacket element engage one another in the closed state of the heating system and form a sealed connection to the exhaust gas line.

50. A method for operating a device for the material treatment of carbon-containing raw materials, the method comprising:
charging a reaction unit with raw materials;
preheating the reaction unit;
opening a heating system and bringing the reaction unit into the heating system;
closing the heating system so that the reaction unit is arranged in a closed space;
heating the reaction unit and starting a charring and distillation process, wherein the charring and distillation process is carried out by selective heating at a substantially constant temperature within the reaction unit, wherein the substantially constant temperature is determined, wherein the reaction unit is charged with a gaseous flushing medium during the charring and distillation process;
introducing gaseous flushing medium into the reaction unit during the charring and distillation process;
discharging developing gases from the reaction unit into a distillation unit through an exhaust gas line connecting the reaction unit and the distillation unit;
determining a temperature of the gases flowing through the exhaust gas line;
cooling and condensing the gases in the distillation unit, wherein the temperature of the gases is controlled by forced cooling of a cooling section of the distillation unit by means of a heat output dissipated by the gases;
introducing distillation products into an oil tank and discharging oil;
extracting non-condensable gases from the oil tank, wherein a negative pressure to the environment is generated within the reaction unit and oxygen is removed from the reaction unit;
opening the heating system and removing the reaction unit from the heating system;
cooling the reaction unit, wherein the reaction unit is charged with a gaseous flushing medium during cooling the reaction unit;
removing final products from the reaction unit, wherein the reaction unit is charged with a gaseous flushing medium during removal of the final products from the reaction unit;
separating the final products removed from the reaction unit; and
removing additional final products from the oil tank.

51. The method of claim 50, further comprising adjusting a pressure within the reaction unit to an absolute value in the range from 2 mbar to 10 mbar.

52. The method of claim 50, wherein cooling and condensing the gases in the distillation unit comprises directing ambient air over the cooling section of the distillation unit in a targeted manner; or flowing a liquid heat carrier fluid through the cooling section.

53. The method of claim 50, wherein during cooling and condensing the gases in the distillation unit, the temperature of the gases is in the range from 95° C. to 125° C.

54. The method of claim 50, wherein during the charring and distillation process an exhaust gas line connecting the reaction unit and the distillation unit is heated to a temperature in the range from 120° C. to 160° C.

55. The method of claim 50, wherein the reaction unit is removed from the heating system when a temperature of the gas flowing through the exhaust gas line is about 60° C.

56. The method of claim 50, wherein the gaseous flushing medium is introduced into the reaction unit at time intervals.

57. The method of claim 56, wherein extracting non-condensable gases and introduction of the flushing medium into the reaction unit take place offset in time with respect to one another.

58. The method of claim 56, wherein the flushing medium is periodically flowed into the reaction unit during cooling the reaction unit for a duration in the range from two to three minutes.

59. The method of claim 50, wherein removing the final products from the reaction unit comprises opening the reaction unit while a temperature inside the reaction unit is in the range from 20° C. to 60° C.

60. The method of claim 50, wherein removing the final products comprises removing carbon from the reaction unit.

61. The method of claim 50, wherein opening the heating system comprises extending support elements which support a head element and a jacket of the heating system.

62. The method of claim 50, further comprising feeding the extracted non-condensable gases to the heating system for combustion within the heating system and for heating the reaction unit within the heating system.

63. Carbon produced by the method of claim 50, wherein the carbon is amorphous and has a structure of a three-dimensional arrangement of carbon nanoparticles as agglomerates, wherein the carbon nanoparticles are cross-linked without long-range order, do not have a large-scale graphitic arrangement and are not arranged as nanotubes, and the carbon has a mass-related specific surface area greater than 4,000 m²/g.

64. Carbon according to claim 63, wherein the carbon has a mass-related specific surface area BET up to 9,500 m²/g BET.

65. Carbon according to claim 63, wherein the carbon has a mass-related specific surface area, in the range from 4,200 m²/g BET to 4,800 m²/g BET.

66. Carbon according to claim 63, wherein the carbon has a density of about 66 kg/m³.

67. Carbon according to claim 63, wherein the carbon has an electric conductivity in the range from 4.5·107 Ωm to 5.8·107 Ωm.
